(19) United States
(12) Patent Application Publication
(10) Pub. No.: US 2011/0090318 A1
(43) Pub. Date: Apr. 21, 2011

(54) Method for generating 3D image

(76) Inventors: Chien-Hung Chen, Taipei County (TW); Chun-Chieh Chiu, Taoyuan County (TW); Yue-Li Chao, Taoyuan County (TW)

(21) Appl. No.: 12/645,460

(22) Filed: Dec. 22, 2009

(30) Foreign Application Priority Data
Oct. 15, 2009 (TW) 098134941

(51) Int. Cl. H04N 13/02; G06T 15/00

(52) U.S. Cl. 348/50; 382/154; 348/E13.074

(57) ABSTRACT

A method for generating a 3D image utilizes a background image and an object image. A camera is used for capturing a 2D image including the background image and the object image. The object image is obtained from the 2D image according the background image. Then, an image from a first angle of view and an image from a second angle of view are generated by rendering the background image and the object image. So, the 3D image is generated by interweaving the image from the first angle of view and the image from the second angle of view.

### BACKGROUND OF THE INVENTION

1. Field of the Invention

The present invention relates to a method for generating a 3-dimensional (3D) image, and more particularly, to a method for generating 3D images by background images and object images.

2. Description of the Prior Art

For providing more realistic display performance, display technology develops from providing large-scale and high-quality display performance to providing 3-dimensional stereoscopic display (described as 3D image in short in the following description) having much more visional compact. The imaging theory of the 3D images mainly utilizes the image difference received by left and right eyes respectively to generate the visional sense of distance.

Conventionally, 3D technology mainly based on the concept of splitting images, splits one image to one left eye signal and one right eye signal and transmits to the left and the right of human eyes. The human brain interweaves the two received signals so that the visional sense of distance can be established. For example, when a user watches a 3D movie, he has to wear a particular glass, which the left eyeglass is red-colored and the right eyeglass is blue-colored. In this way, the user's left and right eyes receive different images. However, this method for display 3D images requires the user to wear the particular glass, and furthermore, the colors of the original images are distorted by the filtering effect from the red-colored and blue-colored eyeglasses of the particular glass.

3D image display technology of the liquid crystal display (LCD) utilizes parallax barriers to have a breakthrough in this field and no longer requires the particular glass for assistance, which the light source can be separated into two directions and the 3D images can be thus created. The purpose of separating the light source of LCD is to simulate the condition that human eyes view an object from two different angles, causing a slight difference between images viewed from the left and the right eyes. Accordingly, the distance between the object and the viewer can be sensed, so the brain can interweave the two images to a complete 3D image. A 3D image comprises a plurality of images of different view angles. The arrangement of pixels for a 3D image has to match the parallax barriers. If the direction of arrangement of the parallax barriers is oblique, then the arrangement of pixels for the 3D image is oblique as well.

A method for generating 3D images is disclosed in U.S. Pat. No. 5,825,997, which a camera is set up at a fixed position, and an object is positioned on a spinning platform. When the camera photographs the object, the spinning platform spins, so that the camera photographs images of the object at different view angles. The images captured by the camera are stored in a memory. When the 3D image producing process is executed, images of the view angles matching the left and the right eyes are retrieved, and then are interwoven to be the 3D image. However, the above-mentioned method requires a lot of memory space for storing the images captured by the camera.

### SUMMARY OF THE INVENTION

The present invention provides a method for generating 3D images. The method comprises storing a background image, utilizing a camera for capturing the background image and a 2D image of an object image, obtaining the object image from the 2D image according to the background image, rendering the background image and the object image for generating an image of a first view angle and an image of a second view angle, and interweaving the images of the first and the second view angles for generating a 3D image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a first embodiment generating 3D images according to the present invention.

FIG. 2 is a diagram illustrating the background image, the captured image, and the object image.

FIG. 3 is a diagram illustrating the images of different view angles rendered by the object image and the background image.

FIG. 4 is a block diagram illustrating generating 3D images according to the second embodiment of the present invention.

FIG. 5 is a diagram illustrating the background image, the captured image, the object image, and the object image depth chart.

FIG. 6 is a diagram illustrating images of different view angles rendered from the object image, background image, and the object image depth chart.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .” Also, the term “electrically connect” is intended to mean either an indirect or direct electrical connection. Accordingly, if one device is coupled to another device, that connection may be through a direct electrical connection, or through an indirect electrical connection via other devices and connections.

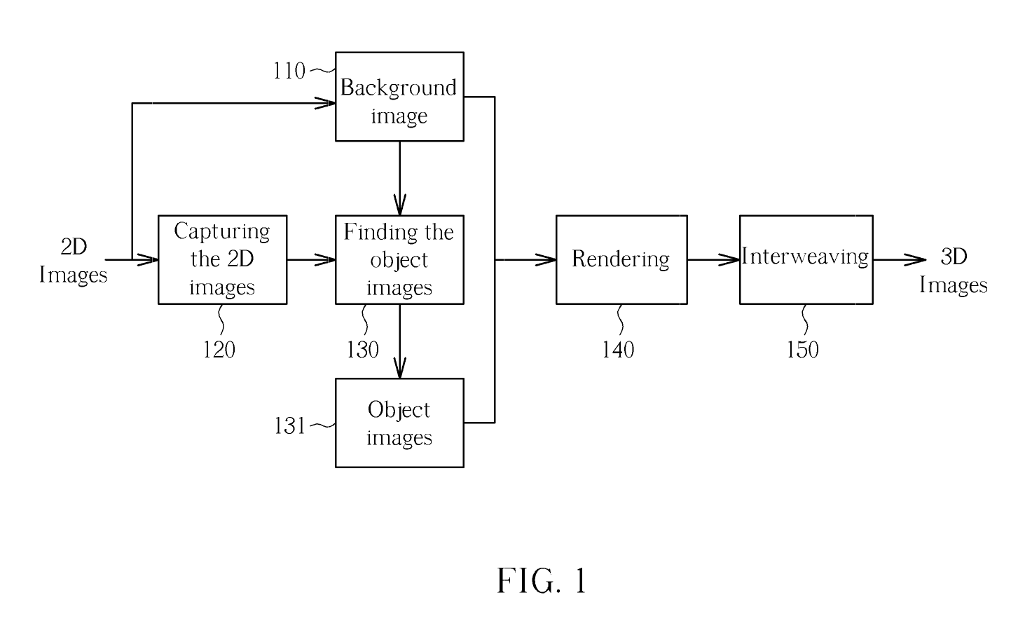

Please refer to FIG. 1. FIG. 1 is a block diagram illustrating a first embodiment generating 3D images according to the present invention. The present invention converting the 2D images to 3D images utilizes a camera for capturing background images in advance, and then stores the background images in the memory. When the images captured by the camera are different from the background images stored in the memory, the object images can be obtained by comparing the captured images and the background images. Then, the object images and the background images are used for rendering images of different view angles. Thus, 3D images can be generated by interweaving the images of different view angles. The method for generating 3D images according to the present invention comprises the following steps:

Step 110: Storing the background images of the 2D images in the memory;

Step 120: Capturing 2D images;

Step 130: Finding the object images from the captured images according to the background images and the captured images;

Step 131: Comparing the grey level values between the background images and the captured images; if the difference between the grey level value of a pixel in the background image and the captured image is higher than a predetermined value, the pixel can be determined to be a pixel of the object image, so as to obtain the object image;

Step 140: Rendering the background images and the object images to obtain 2D images of different view angles;

Step 150: Interweaving the 2D images of different view angle for obtaining 3D images.

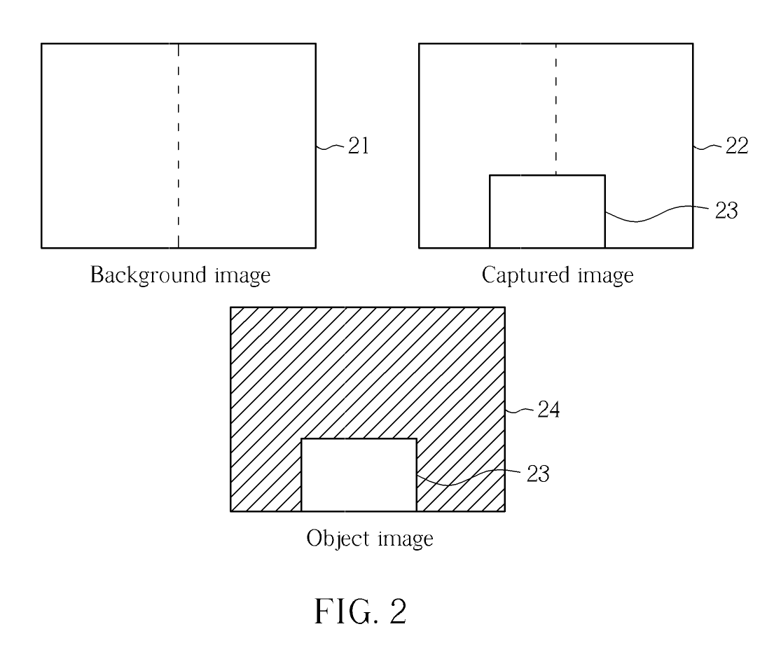

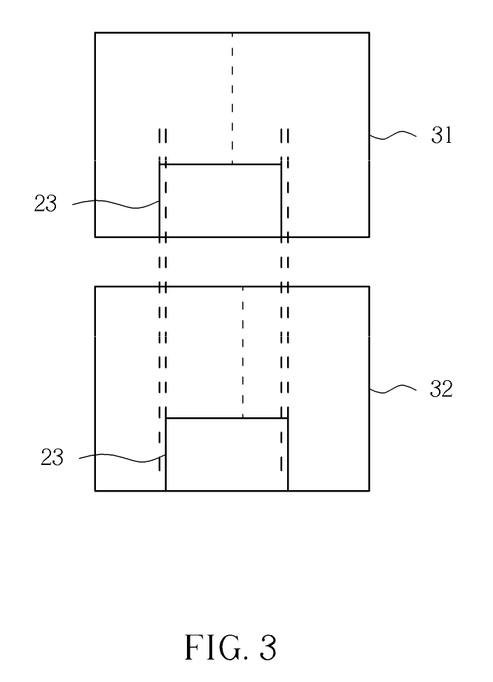

Please refer to FIG. 2 and FIG. 3. FIG. 2 is a diagram illustrating the background image, the captured image, and the object image. FIG. 3 is a diagram illustrating the images of different view angles rendered by the object image and the background image. As shown in FIG. 2, background image 21 of the 2D image has to be established and is stored in the memory before the image is converted from 2 dimensions to 3 dimensions by the method of the present invention. When the object 23 enters the background image 21, the camera generates the captured image 22. After the background image 21 and the captured image 22 are compared, the object 23 can be extracted from the captured image 22 and accordingly the object image 24 is obtained. The comparison can be executed based on the grey level values of the pixels of the background image 21 and the captured image 22. When the grey level difference of a pixel in the background image 21 and the captured image 22 is higher than a predetermined value, the pixel is determined to be a pixel of the object 23, so that the object image 24 can be obtained. As shown in FIG. 3, the image 31 of the first view angle and the image 32 of the second view angle can be obtained through rendering according to the background image 21 and the object image 24. The image 31 of the first view angle is equivalent to the 2D image captured by the camera at the first view angle, and the image 32 of the second view angle is equivalent to the 2D image captured by the camera at the second view angle. By such manner, a 2D image of a third view angle can be further generated. Finally, the image 31 of the first view angle and the image 32 of the second view angle are interwoven for generating 3D images. In this way, only one camera is required for converting 2D images to 3D images by comparing the background image 21 and the captured image 22.

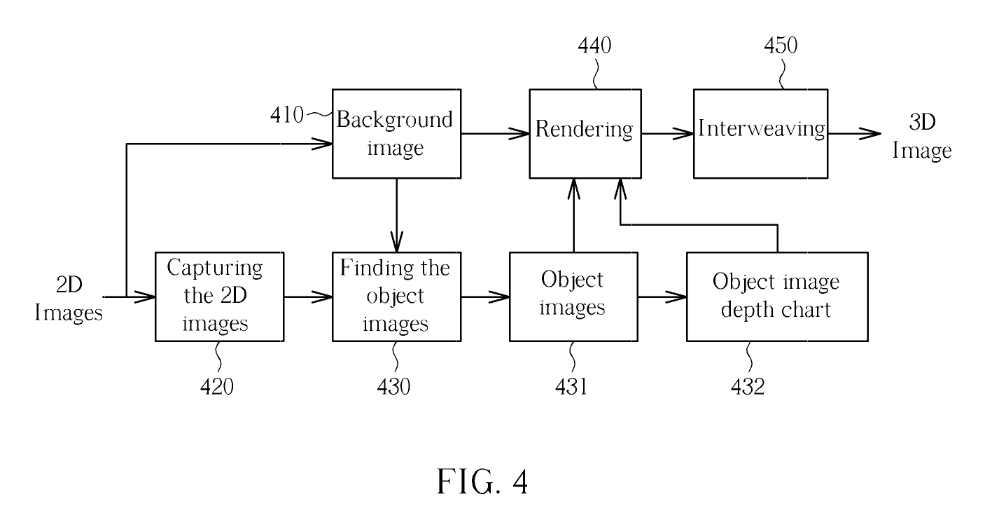

Please refer to FIG. 4. FIG. 4 is a block diagram illustrating generating 3D images according to the second embodiment of the present invention. In this embodiment, a better 3D image obtained by generating object image depth chart from the object is further explained. Similarly, the background image is stored in the memory before the 2D image is converted to the 3D image. When the captured image of the camera is different from the background image stored in the memory, the object image can be obtained by comparing the captured image and the background image. Then, the object image depth chart is obtained from the object image. When the object comprises more than two sub-objects, the object image depth chart can be utilized for representing the depths-of-field (DOF) of the two sub-objects respectively for emphasizing the relative positions of the two sub-objects. Images of different view angles can be rendered according to the object image, object image depth chart, and the background image, and the 3D images can be obtained through the interweaving process. The method for generating 3D images of the present invention comprises the following steps:

Step 410: Storing the background image of the 2D image in the memory;

Step 420: Capturing the 2D image;

Step 430: Finding the object image from the capture image according to the background image and the capture image;

Step 431: Comparing the grey level values of the pixel in the background image and in the captured image; if the grey level difference is higher than a predetermined value, the pixel is determined to be a pixel of the object, so as to obtain the object image;

Step 432: Generating the object image depth chart according to grey level values of the pixels of the object image;

Step 440: Rendering the object image, object image depth chart, and the background image for generating 2D images of different view angles;

Step 450: Interweaving the 2D images of different view angles for obtaining the 3D image.

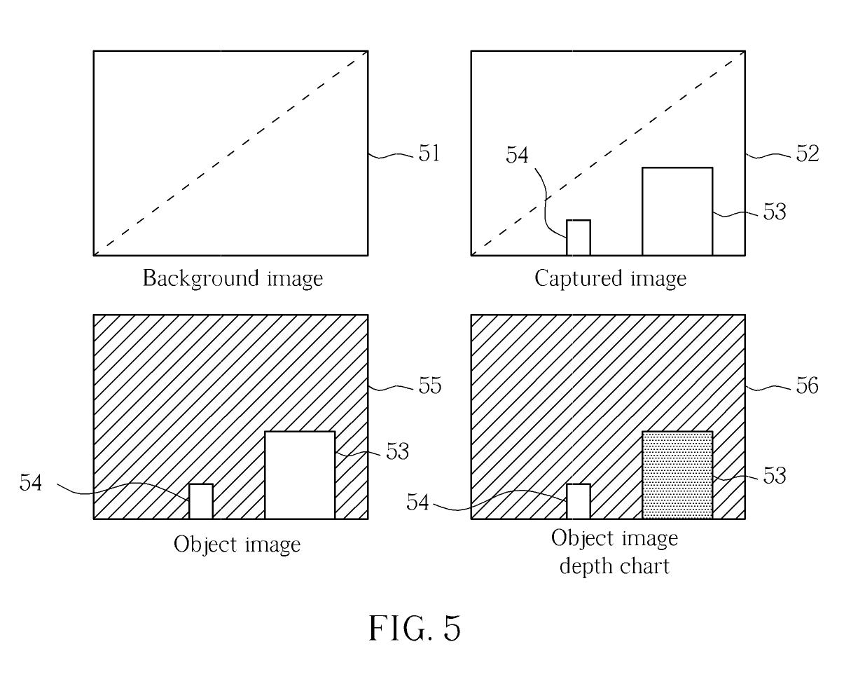

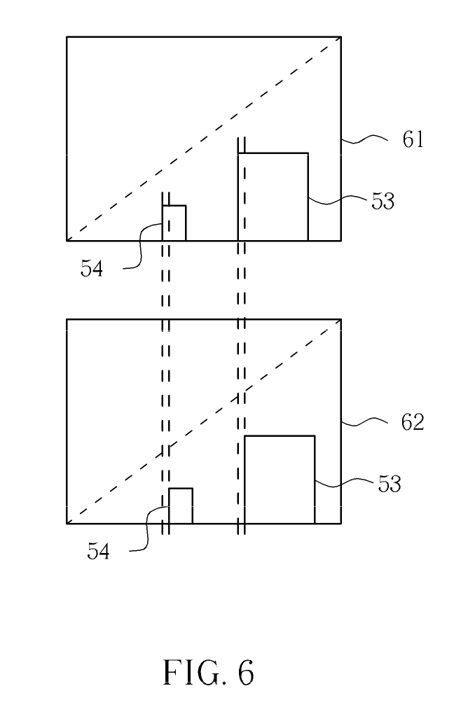

Please refer to FIG. 5 and FIG. 6. FIG. 5 is a diagram illustrating the background image, the captured image, the object image, and the object image depth chart. FIG. 6 is a diagram illustrating images of different view angles rendered from the object image, background image, and the object image depth chart. As shown in FIG. 5, the background image 51 of the 2D image is established and stored in the memory in advance. When the first object 53 and the second object 54 enters the background image 51, the first and the second objects 53 and 54 can be extracted from the captured image 52 for obtaining the object image 55 by comparing the background image 51 and the captured image 52. The comparison can be executed according to the difference between the grey level values of one pixel in the background image 51 and in the captured image 52; when the difference is higher than a predetermined value, the pixel is a pixel of the objects 53 and 54, so as to obtain the object image 55. Furthermore, the relative positions of the first sub-object 53 and the second sub-object 54 can be determined according to the grey level values of the pixels of the first sub-object 53 and the second sub-object 54 in the object image 55. The first sub-object 53 is closer to the viewer than the second sub-object 54, which means the depth of the first sub-object 53 is higher than the depth of the second sub-object 54. As shown in FIG. 6, the image 61 of the first view angle and the image 62 of the second view angle can be obtained by rendering the object image 55, the object image depth chart 56, and the background image 51. By such manner, a 2D image of a third view angle can be further generated. Finally, the image 61 of the first view angle and the image 62 of the second view angle are interwoven for generating 3D images. In this way, only one camera is required for converting 2D images to 3D images by comparing the background image 61 and the captured image 62.

To sum up, the method for generating 3D images of the present invention utilizes the captured image by the camera to compare with the stored background image for finding the object image from the captured image, and generates images of different view angle according to the object image and background image, so as to generate the 3D image. Therefore, only one camera is required for converting 2D images to 3D images in the present invention. Besides, the memory space required by the present invention is much more reduced since only the background image has to be stored. Because the method for generating 3D image of the present invention generates images of different view angles according to the object image and the background image, the present invention is applicable to 3D images with multiple view angles and multiple DOFs.

Those skilled in the art will readily observe that numerous modifications and alterations of the device and method may be made while retaining the teachings of the invention.

What is claimed is:

1. A method for generating 3D images, the method comprises:
storing a background image;
utilizing a camera for capturing the background image and a 2D image of an object image;
obtaining the object image from the 2D image according to the background image;
rendering the background image and the object image for generating an image of a first view angle and an image of a second view angle; and
interweaving the images of the first and the second view angles for generating a 3D image.

2. The method of claim 1, further comprising:
generating an object image depth chart according to the object image.

3. The method of claim 2, wherein rendering the background image and the object image for generating the image of the first view angle and the image of the second view angle comprises rendering the background image, the object image, and the object image depth chart for generating the image of the first view angle and the image of the second view angle.

4. The method of claim 2, wherein generating the object image depth chart according to the object image comprises generating the object image depth chart according to grey level values of pixels of the object image.

5. The method of claim 2, wherein the object image depth chart comprises:
a first sub-object having a first depth value; and
a second sub-object having a second depth value.

6. The method of claim 5, wherein the first depth value and the second depth value represent distance between the first sub-object and a viewer and distance between the second sub-object and the viewer, respectively.

7. The method of claim 1, wherein obtaining the object image from the 2D image according to the background image comprises:
comparing grey level values of pixels in the background image and in the 2D image;
wherein when difference of grey level value of one pixel in the background image and in the 2D image is higher than a predetermined value, the pixel is determined to be a pixel of the object image; and
obtaining the object image according to pixels of the object images.

8. The method of claim 1, further comprising:
generating an image of a third view angle by rendering the background image and the object image.

9. The method of claim 8, wherein interweaving the images of the first and the second view angles for generating the 3D image comprises interweaving the images of the first, the second, and the third view angles for generating the 3D image.

10. The method of claim 1, further comprising:
rendering the background image and the object image for generating images of a plurality of view angles; and
interweaving the images of the plurality of the view angles for generating the 3D image.

11. The method of claim 1, wherein storing the background image comprises storing the background image in a memory.
